(19) United States
(12) Patent Application Publication
(10) Pub. No.: US 2020/0313896 A1
(43) Pub. Date: Oct. 1, 2020

(54) DECLARATIVE SMART CONTRACTS

(71) Applicant: Algorand Inc., Boston, MA (US)

(72) Inventor: Silvio Micali, Brookline, MA (US)

(21) Appl. No.: 16/651,627

(22) PCT Filed: Oct. 4, 2018
(86) PCT No.: PCT/US2018/054311

§ 371 Date: Mar. 27, 2020

Related U.S. Application Data
(60) Provisional application No. 62/643,331, filed on Mar. 15, 2018.
(60) Provisional application No. 62/632,944, filed on Feb. 20, 2018.
(60) Provisional application No. 62/607,558, filed on Dec. 19, 2017.
(60) Provisional application No. 62/580,757, filed on Nov. 2, 2017.
(60) Provisional application No. 62/570,256, filed on Oct. 10, 2017.
(60) Provisional application No. 62/567,864, filed on Oct. 4, 2017.

(51) Int. Cl. H04L 9/32; H04L 29/06

(52) U.S. Cl. CPC H04L 9/3236; H04L 63/12

(57) ABSTRACT

Causing a block in a blockchain to be added to the blockchain includes causing an entity to receive information corresponding to a previous block, causing the entity to receive a declarative invocation of a smart contract execution on a given input, where the declarative invocation declares relevant results of the execution and other relevant data, causing the entity to verify syntactic validity of the invocation, and causing the entity to incorporate the declarative invocation in the block in response to verifying the syntactic validity of the invocation. The relevant results may specify net effects of the smart contract execution, a resulting state of the smart contract after execution, and a number of steps for execution. The other relevant data may specify a caller of the declarative invocation, time information, block information, and/or a payable fee.

### TECHNICAL FIELD

This application relates to the field of electronic transactions and more particularly to the field of securing the contents of sequences of transaction blocks for electronic transactions.

### BACKGROUND OF THE INVENTION

One may think of a smart contract as a computer program that, similarly to a user, can own its own money. Such a contract C may have his own retained (computational) state, possibly modified after each invocation, and his own identifier: for example, the string H(C), where H is a hash function. For simplicity, we denote this identifier by C itself. The reader can easily determine when C is the program itself or its identifier. Preferably, a smart contract C is easily distinguishable from an ordinary user. By a player we mean either a smart contract or an ordinary user.

The execution of a smart contract C can be invoked by one or more proper users. For simplicity, but without any loss of generality intended, herein we assume that C is invoked by a single user i.¹ ¹ After all, when C can be invoked by multiple users, often one of them executes C first, thus modifying its retained state, before another proper user invokes C. The order of the proper users may not matter, if C is stateless. Else, even when say two proper users independently invoke C at the same time, one can pick an order for the two executions, and wait for the first to ‘lied’ before executing the second one. Those skilled in the art may realize that it is possible to write C so that only if invoked by multiple users is C really executed ‘by the system’, and that also these contracts can be handled by our technology.

Let i be a user capable of invoking the system's execution of C. User i invokes C by means of a digital signature. Such a signed invocation of i may specify, in addition to C, an input, input, and a fee, fee. Let us elaborate.
input details a specific input on which to execute C. There may be, of course, additional inputs, such as default inputs: for instance, the current state of C, γ_{C} (that may indeed thought of as an input) and a global state of the the system (e.g., the amount owned by each player at a given block).
fee includes an amount payable by i to ‘compensate the system for the computational cost incurred for the execution of C.’

User i, when invoking C, may also specify some additional information. For instance, he may specify a given block—and thus a given ‘snapshot’ in the blockchain—or that the execution of contract C may take effect in a given block or interval of blocks. Additionally, one may think that the entire blockchain history so far may be taken in consideration by C. In sum, there may also be additional (and possibly implicit) inputs.

The fee may also include the amount that i must pay to include his invocation, as any other transaction, in the blockchain. But let us ignore this latter, traditional fee in order to focus on the problem alleviated by the new invention.

The number of computational steps in an execution of C depends on the machine on which the execution is run. Accordingly, one considers computing C(input) on a fixed (virtual) machine M.

An execution of C generally generates a new retained state γ_{C} and increments or decrements the amounts owned by a few players, x, y, . . . , respectively by:

amount′ₓ,amount′_{y}, . . .

User i's signed invocation of C may enter the blockchain in a given block, only if i, at that point, possesses an amount of money greater than or equal to f ee, the fee specified in i's invocation.

Traditional methods (e.g., nonces) are used to prevent that an invocation indeed corresponds to a single execution. Such methods are not crucial for the problem and invention at hand, and are thus herein ignored, without any loss of generality intended. Similarly, for all sorts of other invention-independent details.

Once i's invocation enters a block in the blockchain, every user u in a class of users U executes C (on the virtual machine M, using the last retained state reached by C) for an amount of steps covered by fee; updates his own version of the blockchain data by subtracting the fee from the amount owned by i; and, if the execution properly terminates, modifies (again, in his own version of the blockchain) the amounts owned by the players affected by the execution of C (possibly including the amount owned by C itself). We may refer to the execution of C by all such users as a system execution of C. Typically, the class U consists of all users or a very large number of users (e.g., all users who wish to contribute to generating a new valid block in the blockchain).

If the number of users is large, the system's total cost may be very high even when the number of steps is somewhat small. This implies that the fee payable by the invoker must also be very high, although the number of steps is not high at all. In this situation, in a blockchain system, it make sense to run only smart contracts that require few steps. This is a pity. The users in the system may benefit from invoking the execution of many smart contracts requiring a non-trivial number of computational steps, but are prevented from invoking them by the exorbitant fees they may have to pay.

### SUMMARY OF THE INVENTION

According to the system described herein, in a transaction system where transactions are organized in blocks, providing new blocks B^{r} and B^{r+1} relative to a sequence of prior blocks B⁰, B¹, . . . , B^{r-1} includes causing the block B^{r} to be constructed after confirming that the block B^{r} indicates initial states of transactions that are consistent with a state of the transactions in the block B^{r-1}, causing the block B^{r+1} to be constructed after confirming that the block B^{r+1} indicates initial states of transactions that are consistent with a state of the transactions in the block B^{r}, and causing a plurality of entities to verify previously-unverified transactions of the block B^{r} after the block B^{r+1} is constructed. The transactions may be smart contracts. A user may construct the block B^{r} in connection with posting a transaction to at least one of the smart contracts in the block B^{r}. The user may also post transaction results for the smart contracts in the block B^{r}. The user may also post a number of steps for execution of the smart contracts results for the smart contracts in the block B^{r}. The user may also post a fee that the plurality of entities receive for verifying transactions of the block B^{r}. The plurality of entities may be a subset of all users of the block B^{r}. The plurality of entities may be chosen randomly. Choosing the plurality of entities randomly may include applying a cryptographic hash function to data that includes at least one of: time information, information about one or more of the blocks, data included in one or more of the blocks, or data deduced from one or more of the blocks.

According further to the system described herein, causing a block B in a blockchain to be added to the blockchain includes causing an entity to receive information corresponding to a previous block, causing the entity to receive a declarative invocation of a smart contract execution on a given input, where the declarative invocation declares relevant results of the execution and other relevant data, causing the entity to verify syntactic validity of the invocation, and causing the entity to incorporate the declarative invocation in the block B in response to verifying the syntactic validity of the invocation. The relevant results may specify net effects of the smart contract execution, a resulting state of the smart contract after execution, and a number of steps for execution. The other relevant data may specify a caller of the declarative invocation, time information, block information, and/or a payable fee. The declarative invocation may be syntactically valid if the fee is adequate for the number of steps for execution and a payer of the fee has sufficient assets to pay the fee, and the fee may be paid if the declarative invocation appears in the blockchain.

According further to the system described herein, causing a set of verifiers in a blockchain to be assigned to verify a set S of one or more declarative invocations of smart contract executions on given inputs, where the declarative invocations declare relevant results of the smart contract executions, includes the verifiers receiving the set S, the verifiers determining which of the declarative invocations in S are semantically valid, and the verifiers providing authenticated responses of the one or more declarative invocations that are semantically valid. The set of verifiers may be selected based on S, in a pseudo-random manner, via a given cryptographic function. At least one verifier may determine that the at least one verifier has been selected via a computation that involves a secret key of the at least one verifier, and the at least one verifier may prove to others that the at least one verifier has been selected. An invocation I in S may be considered correct if responses of at least a given number of verifiers assigned to S indicate that I is semantically correct.

According further to the system described herein, in a blockchain in which a set S of declarative smart-contract invocations has already been registered, a set of verifiers assigned to S, and the verifiers have provided authenticated responses about which of the invocations of S are semantically valid, causing a verdict of the invocations of S to be incorporated in the blockchain includes having an entity receive the authenticated responses of the verifiers, having the entity deduce correctness of the invocations of S, and having the entity incorporate in the blockchain a final verdict about correctness of the invocations of S. The final verdict of an invocation I in S may indicate that I is correct if the responses of at least a given number of the verifiers assigned to S indicate that I is semantically valid. If the final verdict of an invocation I of S indicates that I is correct, other users may be caused to update the state of the smart contract and to consider the declared net effects of the execution of the smart contract to have taken place.

According further to the system described herein, causing a block B in a blockchain to be added to the blockchain includes causing an entity to receive information corresponding to a previous block, causing receipt of a committed declarative invocation of a smart contract execution on a given input, where the committed declarative invocation declares at least some relevant results of the execution, a commitment to other relevant results of the execution, and other relevant data, causing verification of the syntactic validity of the committed declarative invocation, and causing incorporation of the committed declarative invocation in the block B in response to verifying the syntactic validity of the committed declarative invocation. The relevant results may specify a net effects of execution, a resulting state of the contract after execution, and/or a number of steps and the other relevant data may specify a caller of the invocation, time information, block information, and/or a payable fee. The declarative invocation may be syntactically valid if the fee is adequate for the number of steps and the payer of the fee has sufficient assets in the system to pay the fee, and the fee may be paid if the invocation appears in the blockchain.

According further to the system described herein, causing a set of verifiers in a blockchain to be assigned to verify a set S of declarative invocations, including at least one committed declarative invocation I specifying an execution e of a smart contract on given inputs, where I includes a commitment to at least some relevant results rr of e, includes the verifiers receiving the set S, the verifiers reconstructing execution e so as to compute the relevant results rr, and the verifiers providing authenticated responses including personalized commitments to rr of the verifiers. The assigned verifiers may be selected based on S, in a pseudo-random manner, via a given cryptographic function. At least one verifier may determine that the least one verifier has been selected via a computation that involves a secret key of the least one verifier, and the least one verifier may prove to others that the least one verifier has been selected. The committed declarative invocation I in S may be considered correct only if responses of at least a given number of verifiers assigned to S include a personalized commitment to the relevant results rr committed to in I.

According further to the system described herein, in a blockchain in which a set S of declarative smart-contract invocations has already been registered, a set of verifiers assigned to S, where the set S includes at least one committed declarative invocation I specifying an execution e of a smart contract on a given input, and where I includes a commitment to at least some relevant results rr of e, and the verifiers have provided authenticated responses about the invocations of S, causing a verdict of the invocations of S to be incorporated in the blockchain includes having an entity receive the authenticated responses of the verifiers, having the entity deduce correctness of the invocations of S, and having the entity incorporate in the blockchain a final verdict about the correctness of the invocations of S. The responses of at least a given number of the verifiers assigned to S may include a personalized commitment to the same relevant results rr committed to in I, and the final verdict of the committed declarative invocation I in S may indicate that I is correct. The final verdict of the correctness of I may cause other users to update the state of the smart contract and to consider the net effects of the execution e of the smart contract to have taken place.

According further to the system described herein, computer software, provided in a non-transitory computer-readable medium, includes executable code that implements any or all of the steps described herein.

### An Alternative Technology for Smart Contracts

We present a new technology to implement smart contracts on a blockchain. Our new technology can be implemented alongside traditional ones, and can efficiently handle a class of contracts that are too expensive to handle via traditional technologies.

### A Large Class of Contracts

The new technology is especially helpful for smart contracts whose
internal/computational state (state, for short)—which may change from execution to the next—and
net effects—e.g., new state, money transfers from one party to another, etc.—can be compactly described. Let us emphasize that our technology allows one to handle also smart contracts that require
very many computational steps and
a very large amount of memory.

Indeed, the memory used in an execution may be very large, while the state information retained for the next execution may be very compact—e.g., consisting of a few bounded-value variables. Importantly, stateless smart contracts trivially satisfy this property and are very powerful.

Of course, some smart contracts may need to be stateful in order to achieve a given desideratum. In light of our new technology, however, it will be in the interest of application designers to architect such contracts so as to compactify the size of their retained state.

### A Blockchain-Agnostic Technology

The technology makes novel use of (secret) cryptographic sortition, the cryptographically secure self-selection technology that is a key component of the Algorand technology, which is described in PCT patent application PCT/US2017/031037 filed on May 4, 2017, which is incorporated by reference herein. The Algorand technology is also described in most, if not all, of the patent applications incorporated herein by reference in another section of the application.

However, despite its other advantages, one does not need to use Algorand as the underlying blockchain platform in order to use our new technology for handling a new class of smart contracts. The new technology can used with any other platforms, such as Bitcoin, Ethereum, etc.

This said, as we shall point out later, using Algorand as the underlying blockchain engine will bring about some additional advantages.

### BRIEF DESCRIPTION OF THE DRAWINGS

Embodiments of the system described herein are explained in more details in accordance with the figures of the drawings, which are briefly described as follows.

FIG. 1 is a schematic representation of a network and computing stations according to an embodiment of the system described herein.

FIG. 2 is a schematic and conceptual summary of a blockchain that incorporates the system described herein.

### DETAILED DESCRIPTION OF VARIOUS EMBODIMENTS

The system described herein provides a mechanism that improves efficiency and decreases computations needed by workstations (versifiers) to verify blocks in a blockchain that contain smart contracts.

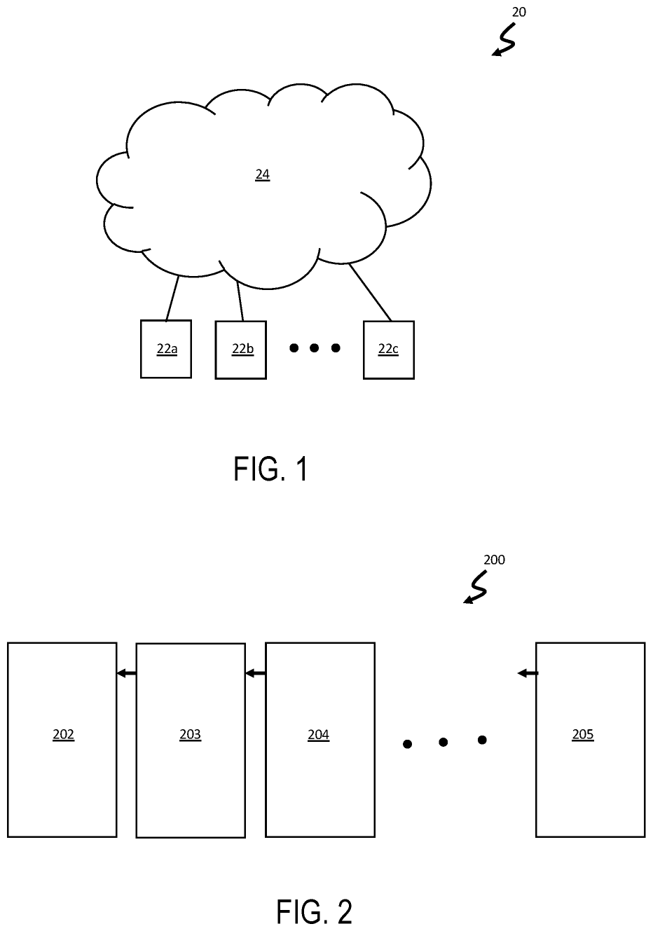

Referring to FIG. 1, a diagram shows a plurality of computing workstations 22a-22c connected to a data network 24, such as the Internet. The workstations 22a-22c communicate with each other via the network 24 to provide distributed transaction propagation and verification, as described in more detail elsewhere herein. The system may accommodate any number of workstations capable of providing the functionality described herein, provided that the workstations 22a-22c are capable of communicating with each other. Each of the workstations 22a-22c may independently perform processing to propagate transactions to all of the other workstations in the system and to verify transactions/blocks and act as verifiers, as described in more detail elsewhere herein.

Referring to FIG. 2, a blockchain 200 includes a plurality of blocks 202-205. Each of the blocks contains one or more smart contracts and additional information, as described in more detail elsewhere herein. The block 202 is an oldest block of the blockchain 200, the block 203 is a next oldest, etc. The block 205 is a newest block of the blockchain 200. There may be any number of blocks in the blockchain 200. Each of the blocks 202-205 contains information that validates a previous block so that, for example, the block 203 contains information that validates the block 202 and the block 204 contains information that validates the block 203. Thus, the latest validated one of the blocks 202-205 in the blockchain 200 directly validates a preceding block and indirectly validates all other preceding blocks. In an embodiment herein, each of the blocks 202-205 contains a signed hash of a previous one of the blocks 202-205, although other mechanisms may be used to validate/confirm previous blocks, including a number of conventional blockchain mechanisms known in the art. In addition, one or more of the blocks 202-205 may be verified and may include a verdict as to the block's authenticity, as described in more detail elsewhere herein. One or more newest ones of the blocks 202-205 may be initially unverified and may subsequently become verified and authenticated, as described in more detail elsewhere herein.

Ideally, the fee for invoking an execution of a smart contract C should correspond to the total cost of the computation that the execution causes the system to incur. But:
What is the system's total cost of an execution of C?

If there are n users, and the execution of C (on the given machine M) consists of #steps, then the total system cost can be estimated to be

n×#steps.²

² Here we assume that every user ascertains the correctness of a new block and runs every smart contracts it contains. In some blockchain platforms, only full nodes have this responsibility, but not light nodes. Either way, n can be very large.

Thus, if n is large, the system's total cost may be very high even when #steps is somewhat small. This implies that the fee payable by the invoker i of C must also be very high, although #steps is not high at all. In this situation, in a blockchain system, it make sense to run only smart contracts that require few steps. This is a pity. The users in the system may benefit from invoking the execution of many smart contracts requiring a non-trivial number of computational steps, but are prevented from invoking them by the exorbitant fees they may have to pay.

We find convenient to describe the inventive technology in a specific choice of parts. It should be understood, however, that each part is itself novel and can be used in isolation, and that other divisions in parts are also possible within the scope of invention.

### 1. Invocations.

A declarative invocation I of a smart contract C specifies the relevant results on an execution e of C (on given input/inputs and initial state) and other relevant data.
Relevant results may include the new state reached by e and the player-amount adjustments corresponding to e.
The relevant data may include an indication of the contract, state, and inputs in question; the number of steps of e (relative to a machine M of reference), or an upperbound to such a number of steps; and a fee, representing the cost or an upperbound to the cost that the invocation causes to the system. (As we shall see this cost may be significantly smaller than that caused when all users execute e.)
The relevant data may also include an indication of at least a proper user i responsible for the invocation, and i's digital signature (or another form of authentication) signifying that i indeed accepts responsibility for the invocation, including its cost to the system. Such a user i may indeed have himself generated the execution so as to compute its relevant data.

The relevant data may also include an indication of a block or a set of blocks in which the invocation is expected to be officially registered, that is appear, in the blockchain. (Indeed, user i may disavow responsibility for the invocation if it does not enter the blockchain in r.)

For simplicity, we may more simply refer to a declarative invocation I as an invocation.

### Discussion and Additional Details

As before, a proper user i invokes the system's execution of C on an input input by propagating a digital signature of his. This time, however, i's signature, in addition to C, input, and a correct fee, also authenticates the effects of the execution of C and the number of steps taken by the execution.³ ³ Note that the above information may be somewhat redundant. This is for clarity, and does not intend to impose any limitations. For instance, the fee can be determined, via the current ‘price list’ of the system, from the other quantities, such as their total length (or, say, just the length of the effects) and/or the number of steps. Similarly, the number of steps can be upperbounded by the fee, and so on. Throughout, a mentioned quantity that can be deduced/estimated from other quantities, may not appear explicitly, but deduced/estimated.

In a sample setting, i first computes an execution e of C(input), or has some one else compute e for him, so as to figure out which results the execution e will have, and then requests the system to confirm these results. In the execution e, C starts with the retained state γ_{C}: namely, the latest retained state reached by C after the sequence of executions of C recorded in the blockchain.

For example, but without loss of generality, i computes and starts the propagation of

invokeᵢ [symbol] SIGᵢ(i,r,C,input,#steps,γ_{C},γ′_{C},(x,amount′),(y,amount′_{y}), . . . ,fee)

where
i is an identifier of the invoking user, mainly included for convenience, if deducible from i's signature.
C the contract in question.
r, in this example, is the specific single block in which i expects the invocation to be registered and i disavows responsibility for the invocation if it is not registered in block r
r′, possibly an indication of a future block. (E.g., to convey that the invocation should be discarded if a final verdict about the invoked execution does appear in the blockchain by block r′.)
input is the input(s) i on which i chooses to invoke the execution of C.
#steps is the number of e (on given machine M of reference).
γ_{C} is the initial state, and γ′_{C} is the new retained state of C generated by e.
(x, amount′ₓ), (y, amount′^{y}), . . . are the player-amount adjustment pairs generated by e.
fee is the amount of money payable by i (in this specific example).
n the (expected) size of the set of verifiers to the invocation (which will be discussed soon).
t, an integer, possibly included to indicate the number of coherent responses about the invocation required to consider the invocation correct (a notion that we shall also discuss soon).

We may refer to invoke as the invocation—of i of C(input)—and to

(i,r,C,input,#steps,γ_{C},γ′_{C},(x,amount′ₓ),(y,amount′_{y}), . . . ,fee,n,t)

as the declared execution summary.

The payable fee may depend upon some chosen quantities, such as (without any limitation intended) #steps, the size of the declared execution summary, and the size of the resulting state γ′_{C}. It is thus important to design C so that its states are compact, and to focus on contracts whose net effects can be compactly described. The fee may also depend on the quantities n and t, if the invocation includes such quantities. The fee may also depend on other quantities yet, such as the size of the final verdict, which we shall soon discuss. We say that the fee is adequate if it indeed equals or exceeds the amount corresponding to the chosen quantities.

In sum, invoke essentially is i's request to the system to verify the correctness of the declared execution summary and then to (a) update the new retained state of C, and (b) adjust the amounts owned by the players affected by the execution of C.

Let us now see how such an invocation I is registered.

### 2. Registration.

An invocation I may enter the blockchain very much like an ordinary payment. Invocation I may be propagated from user to user until some user u in charge of generating a new block puts it into his block. Preferably, u should check whether I is syntactically valid.

Checking syntactic validity requires checking some simple conditions. For instance, it may include checking that the initial state of C indicated in I coincides with the final state indicated in the last invocation of C registered in the blockchain. Or that the invoking user, if any, is indeed entitle to make the invocation. Thus registering an invocation in the blockchain does not require having to execute C.

Syntactic validity may also include checking that a user i invoking I indeed owns enough money to pay the fee specified in I. Indeed such a fee may be automatically paid by i. (One may also consider a contract to be responsible for the payment of the fee—e.g., because it is a contract that has called an invocation. If the fee is paid from money owned by such contract, then syntactic validity may including checking whether the contract has sufficient money to pay the fee. In this case, such a fee may be automatically paid by the contract, when I enters the blockchain.)

Syntactic validity may also include checking that I's fee is adequate to the number of steps indicated by I.

A block including a non-syntactically valid smart-contract invocation is considered invalid. Accordingly, an honest u should not include a syntactic invalid invocation in a new block.

Syntactic validity may also be checked during the propagation of I. Indeed, a user x receiving a non-syntactically valid I may not forward it to other users.

### Discussion and Additional Details

Note that syntactic verification of an invocation I is typically much lighter than its corresponding semantic verification. By the latter term, we mean verifying that carrying out the execution e invoked by I indeed yields the declared execution summary. Such semantic verification can be very long, because an execution of a smart contract may take a high number of steps.

Accordingly, it is a main advantage that in the preferred embodiment a block constructor u only verifies the syntactic validity of I but not its semantic one. A typical block contains thousands of transactions and assume, for example sake, that 1,000 of them are smart-contract invocations, and that executing each one of them takes, on average, 1 second of computation. Then, even disregarding all other computations, to construct a new block u would need at least 1,000 seconds (i.e., some 16 minutes), if he had to verify the semantic validity of the invocation of the new blocks he produces. This is indeed what a block contractor would be required to do in the traditional smart-contract model. However, producing a block every 16 minutes may be too slow. One would rightfully prefer to produce a new block in a few seconds!

This slowness would be even worse if, during message propagation, users were required to check the semantic validity of the invocation they forward to other users.

In the preferred embodiment, an invocation is considered official when it enters the blockchain, and only at that time will the system start putting the necessary effort to check semantic validity. As we shall see, however, the total system effort will be quite contained and practical.

### 3. Assignments.

A set S of one or more smart-contract invocations, registered in one or more blocks, is assigned to a set of smart-contract verifiers.

For instance, S may consist of all smart-contract invocations included in a given block. Alternatively, S may consist of a single invocation. Alternatively yet, the invocations of a given block can be partitioned into several sets. For instance, the first set may consist of the first k smart invocation, for some given integer k; the second set may consist of the next k; and so on. (Except that the last set may contain less than k invocations.) As for another example, the smart contract invocations of a block may be partitioned (e.g., in some canonical way) into a number of sets, so as to control the total number of steps declared in the execution summaries of each set. For instance, the first set may consist of the first k invocations in the block, if the sum X of the number of steps in their declared execution summary does not exceed a given number N, while the sum of X and the number of steps in the declared execution summary of the next invocation is greater than N. The set S may depend on the (expected) size of the verifier sets. For instance, S may group invocations specifying a similar (expected) size of verifier sets.

The set of smart-contract verifiers assigned to S, V_{S}, is sufficiently random and sufficiently numerous, so as to ensure that, with high probability, the majority of the selected verifiers are honest, assuming that a given majority of the users are honest. Also a verifier in V_{S} can be selected proportionally to the amount of money he currently owns in the system, or own at a given point in time, according to the blockchain. In this case, a verifier can be selected to belong to V_{S} with a greater weight, meaning that he has two or more votes, and one may want to insures that the majority of the votes are in honest hands.

Also, the set V_{S} is preferably checkable. That is, either (a) one is able to compute V_{S}from S, or (b) a verifier in V_{S} is able to determine that he is indeed a member of V_{S} and, if this is so, he is able to prove to others that this is indeed the case.

### Discussion and Additional Details

The invention assigns to each set S of smart contracts a relatively small set of verifiers, V_{S}, who will invest the time necessary to verify the semantic correctness of the declared execution summaries of the invocations in S, sparing others users in the system to do the same work. If V_{S} were small and fixed, the system would not be very secure, because an adversary might with time corrupt all of the verifiers or a majority of them.

To protect against this eventuality, each V_{S} is selected at random or in a pseudo-random manner, based on S and some additional information P. For instance, one may use a hash function or another suitable cryptographic function H: e.g., V_{S}=H(S, P). A possible choice of P may include time information, information about the block or blocks in which S appear, data included in these block or deducible from these blocks or more generally from the blockchain, etc., including no information. (Note that V_{S} can be selected based on S, by being selected based on the block or blocks in which S appear. For instance if S is the set of all invocations of block B or block number n, then V_{S} can be selected based on B or n. As for another example, if S is the second set of invocations, in some given order, of block number n, then V_{S} can be selected on based on information that includes the pair (n, 2). Being selected based on S includes being selected based on S and other information.)

This random choice of V_{S} makes it much harder to an adversary to corrupt some of the verifiers in V_{S}. Indeed, the set of verifiers may change dramatically every time.

Ideally, the verifiers in V_{S} are selected via a secret sortition method. In such a method, a user v secretly learns whether he is a verifier in V_{S}, but can prove it to others, if this is indeed the case. For instance, v may use a secret key of his to compute whether he belongs to V_{S}. For instance, v may compute SIGᵥ (S, P) and check whether the so computed datastring satisfies a given property. One such property, without any limittion being intended, may be having the value SIGᵥ(S, P) or its hash be smaller than a given number t. Indeed, SIGᵥ(S, P) like any other data string may be uniquely interpreted as a number, and this number is easily compared with the “target” number t. For instance, if t=0.001, then the probability that H(SIGᵥ(S, P))≤t is 1 in a thousand, if the cryptographic function H is treated as a random function. Accordingly, in this example, 1 in a thousand of the possible users are verifiers in V_{S}. Notice that the verifier set V_{S} of this example is checkable. Indeed, if v belongs to V_{S}, then v can prove that this is the case by releasing his signature SIGᵥ(S, P). In fact, given this datastring anyone could tell whether it possesses the desired property that determines belonging to V_{S}. But until v reveals SIGᵥ(S, P), it would be very hard for an adversary to corrupt v, for the simple fact that he does not know who v is! Indeed, v is secretly selected, because only he knows the secret key (his secret signing key in the above example) that determines whether v belongs to V_{S}. Indeed, choosing V_{S} via secret sortition is very secure.

### 4. Verification.

When the set of smart-contracts S is registered (appears) in the blockchain, each verifier v in V_{S} verifies the semantic correctness of each invocation I in S, and then authenticates and propagates his responses.

If the set V_{S} is selected via secret sortition, then v also propagates a proof that he indeed belongs to V_{S}.

Verifier v may authenticate his response about each I in S separately. For instance by computing and propagating SIGᵥ(I, valid).

Verifier v may also authenticate all his responses together, indicating which invocations are valid and which are not. For instance, if the invocations in S are I₁, I₂, I₃, I₄, . . . , and the invocations I₁, I₃, . . . are valid and the invocations I₂, I₄, . . . are invalid, then v may compute and propagate:

SIGᵢ((I₁,valid),(I₂,invalid),(I₃,valid),(I₄,invalid), . . . )

More compactly, v may use 1 to indicate validity and 0 to indicate invalidity. Thus, for the example above, he may authenticate all his responses together by propagating SIGᵢ((I₁,1), (I₂, 0), (I₃, 1), (I₄, 0), . . . ). More compactly yet, if the invocation in S, I₁, I₂, I₃, I₄, . . . , are actually ordered in some predetermined and unambiguous fashion, in the above case v may propagate SIGᵥ(1, 0, 1, 0, . . . ). That is, the first 1, being in the first position, indicates that the first transaction, that is, I₁, is valid; the first 0, being in position 2, indicates that the second transaction, that is I₂ is invalid; and so on.

Verifier v may also authenticate his responses together, but so as to allow one to extract v's authenticated response about an individual invocation in S. For instance, v may construct a Merkle tree, each leaf of which stores v's response about a separate invocation in S, and then authenticate the value stored at the root of the Merkle tree.

An honest verifier in V_{S} only provides the right response (and thus a single response) about each invocation I in S.

Whatever method the verifiers in V_{S} may use to authenticate which invocations of S they consider valid and which they consider invalid, an invocation I in S may be considered correct, if at least a given number X of the verifiers in V_{S} authenticate that I is semantically valid, and incorrect otherwise. Alternatively, I may be considered incorrect, if at least a given number Y of the verifiers in V_{S} authenticate that I is semantically incorrect. To maximize meaningfulness, X and Y are chosen to be large enough so that, when the majority of the verifiers in V_{S} are honest, (a) each invocation I in S that is semantically valid will be considered correct and will not be considered incorrect; and similarly, (b) each invocation I in S that is semantically invalid will be considered incorrect and will not be considered correct.

### Discussion and Additional Details

Having the verifiers in V_{S} propagate their authenticated responses about the semantic validity of the invocations in S is not enough. For instance, a user who recently joins the system and learns the entire blockchain so far may have no idea about what was propagated before he joined. Accordingly, although he sees that an invocation I has been registered on the blockchain, he does not know whether I is correct or not. It is thus important to register a final “verdict” about I on the blockchain itself.

Recall that Merkle trees are very well known in the literature. A merkle tree allows one to authenticate many pieces of information, stored in the nodes of the tree, relative to the value r stored in the root of the tree. To authenticate any value v stored in a node of the tree, one has to provide an authenticating path, from the root to the node storing v. Such path can be much shorter (e.g., logarithmically shorter) that the sequence of values authenticated within the tree. If the value r is not known, to authenticate a value v stored in a node of the tree, one can authenticate r separately (e.g., via a digital signature) and then provide an authenticating path for v relative to r.

### 5. Verdicts.

A user u constructing a new block, may include in such a block not only valid ordinary transactions (e.g., valid payments) not yet appearing in the blockchains, but also the final verdict, that is, information about the correctness or the incorrectness, whichever the case may be, about invocations previously registered in the chain. Preferably, such information is provided for transactions for which no final verdict has yet appeared in the chain.

Let S be a set of invocations previously registered on the blockchain and u a user constructing a new block B. Then, after receiving the responses of sufficiently many verifiers in V_{S}—so as to learn, for each I in S, whether I is correct or not—u may include in B the final verdict about invocations in S (e.g., all invocations in S). Such final verdict may also include information identifying the set S itself, and is preferably authenticated. If u authenticates B, then such verdict is automatically authenticated by u. Alternatively, u may separately authenticate the final verdict about invocations in S. For example, to specify the final verdict about invocations in S, u may use one of the methods used by a verifier in V_{S} to convey his response about the semantic validity of invocations in S.

Alternatively, u may include in the block the authenticated responses of sufficiently many verifiers of V_{S}, so as to enable one to determine from such included responses invocations in S that are valid and invocations of S that are not. Possibly, together with such responses, u may also include one or more datastring proving that the verifiers in question indeed belong to V_{S}.

Alternatively, u may include in his block the responses about S of some verifiers of Sᵥ, preferably verifiers whose responses have not yet been recorded in the blockchain, although the correctness of invocations in S cannot be deduced solely from such included information. However, a user may deduce the correctness of invocations of S over multiple blocks. The final verdict about an invocation I of S may in fact be reached when sufficiently many responses recorded on the chain attest the correctness or the incorrectness (whatever the case may be) of I.

User u may include include in B information about the correctness of all the invocations in S, or just one or more of them. For instance, he may include in B one or more response of verifiers in V_{S} about one or more invocations I in S. Or he may include information from which one may deduce the correctness of at least some transaction(s) in S. If the verifiers in V_{S} authenticate their responses about the validity of the invocations in S in a way to enable one to extract their authenticated response about just some transactions I in S, then u may include such extracted authentication about I. For example, if a verifier v in V_{S} authenticates his response about the invocations in S by authenticating the root r of a Merkle tree, then, to include in B v's authentication of an invocation I in S, u may include v's authentication of r and an authenticating path from r to a value including i's response about the validity of I.

### Discussion and Additional Details.

A block B may be considered valid not only id its ordinary transactions are valid, but also if its final verdicts about previously registered invocations are valid.

In a blockchain that relies on proof of work in order to produce new blocks, a honest miner does not link a new block to an invalid block.

In a blockchain, like Algorand, in which a new block B is proposed and then voted or agreed upon by a proper sets of users (e.g., a proper set of verifiers) in order to be added to the chain, an invalid block may probably not be voted or agreed upon.

The protocol may allow the concurrent execution of a given contract, or impose a specific order of execution among executions of C, including disregarding some of such executions. For instance, if an invocation I of a given contract C is registered on the blockchain, the protocol may prevent another invocation of C to be registered on the blockchain, until a final verdict about I appears on the blockchain. In particular, a user u building a new block B may not include in B two or more executions of C. Alternatively, two or more invocations of C may appear, but one of them is chosen (e.g., in some predetermined fashion) to be executed first. The other(s) may never be executed, or executed only after a final verdict about the first has been reached. Alternatively yet, one is chosen to be executed first, and then the second one, and so on, depending on the type of contract and what the contract specifies.

An invocation I of a contract C may also include a block number r so that no final verdict about I can enter the blockchain after block r. Alternatively, such r cn be determined automatically, based on the block in which I is registered and the number of steps declared in I. This enables a new invocation of C if the original one remained without final verdict. In such a case, one may consider automatically reimbursing the user responsible for the invocation I for the fee he paid when I was registered in the blockchain.

Once (an indication of) the final verdict of an invocation I of a contract C enters the blockchain, if the verdict is positive, then a user x realizing this properly updates the current state of C and considers all the relevant net effects having taken place. (E.g., if the invocation I declares a given payment form a user to another user, then the money owned by such users is automatically updated.) If the final verdict is negative, then no update of the state of C occurs and no net effects take place. However, an additional fee may be imposed automatically to the user responsible for the invocation I.

### 1 General Analysis

### Security, Efficiency, and Cost

The response of a single verifier v about the invocations of a given set S would be enough, if one were sure that v were honest. But, of course, a block contructor/proposer or anyone else may not know which verifiers are honest. However, it is easy to be confident about the honesty of a majority of the verifiers. Thus, if sufficiently many, preferably randomly selected, verifiers tell all other user which invocations of S are valid and which are not, then one can learn the correctness of the invocations of S, without having to verify their validity himself! This is why the inventive scheme is secure and efficient at the same time.

For example, if 80% of the users are honest, the number of verifiers of I in S is about 500, then the response of 300 verifiers may indeed guarantee extremely high security. At the same time, if S contains, for example, 100 invocations, then, on average, only 5 users verify the validity of each invocation, making the system extremely efficient, in addition to extremely secure.

Since relatively few verifiers (especially on average!) directly check the validity of a declared execution, the fee required to register a given execution can be very low. In fact, it needs to reimburse the computational costs of very few users: in the above example of just 5 users, on average, rather than—say—all users in the system. The fee required to invoke a smart contract is often referred to as “gas”. Accordingly, in the inventive system,
Gas is much cheaper for very many and desirable types of contracts!

Great security, coupled with great efficiency, and low costs may make the inventive system very appealing for a large class of smart contracts, and may indeed may allow the large scale use of such contracts.

In fact, with the inventive system, smart contracts may have much longer execution time than in other systems, yet causing a much lesser amount of total computation.

### Weighting for Money

Note that, throughout this application, the set of verifiers V_{S} of a given set S of invocations can be selected, like in Algorand or other blockchains at least partially based on some form of proof of stake, based on the amount of money they own in the system at a given moment (e.g., when S is registered in the blockchain). In fact, a given user may enter V_{S} with multiplicity greater than one. Indeed, Sᵥ can consists of a number of votes of a set of verifiers, where each verifier may have more votes, depending on the amount of money he owns. That is, the inventive system applies also when one assumes that the majority of the money is in honest hands.

### Computational Efficiency

Note that, although n, the number of users in the system could be enormous (e.g., n=100 M), only T (e.g., T=500) verifiers need to execute C(input). Thus, the total computational cost of an execution of C with the inventive technology is ≤500 #steps rather than 100 M #steps. Accordingly, smart contracts in Algorand may have much longer execution time than in other systems, and yet causing a much lesser amount of total computation. In other words, the new technology enjoys much greater flexibility and enables the use of a much larger class of smart contracts.

### Cost Efficiency

The computational efficiency of the new smart-contract technology automatically implies cost efficiency. Consider invoking an execution of a smart contract C requiring 1 hour of computation in a system with 100 M users. In such a system, the fee of a traditional invocation of C needs necessarily be very high, because it must essentially cover the total cost of 100 M hours of computation. By contrast, with the new technology, the corresponding fee for the same invocation of C need to cover only 500 hours of computation. In fact, this latter cost not only is modest, but remains the same even if the total number of users in the system is 1B or higher! Put it in another way, in the new inventive system,
‘Gas’ is much cheaper for very many and desirable types of contracts!

### Thruput Efficiency

With the inventive technology, an invocation I of a contract C registered in a block B triggers the execution of C, by a set of proper verifiers, ‘off chain’. Thus, even if such execution takes a long time, no long time is needed to check the validity of block B. Thus the generation of the next block can start right away. In other words, the inventive system can have a very high throughput. Once the proper verifiers of I complete their executions, even is such an execution took a long time, the final verdict about I enters the blockchain without slowing down the chain at all. By contrast, in traditional method, if I is posted in block B, the invocation of e must be finished before producing the next block. Therefore the new technology makes it possible to produce new blocks in few seconds seconds, even if blocks contain smart contracts whose executions required individually or in total, one hour of computation.

### 2 Variants and Additions

Above we presented our preferred embodiment. Those skilled in the art realize that several other variants and alternative are possible, all of which are within the scope of the invention. Below we just consider just some of them.

Final Verdicts without Invocation Registration

In the preferred embodiment, an invocation I must be registered on the blockchain in order to trigger its ‘system execution’. Alternatively, however, I may not be put on the blockchain, but (an indication of) its final verdict may. For instance, I may just be propagated, until it is noticed and processed by sufficiently many of its verifiers, who then propagate their individual responses about I, and only once he sees sufficiently many coherent responses, does the constructor of a new block B includes in B information about the final verdict of I. (E.g., the signed individual responses of some or sufficiently many of the verifiers of I.)

### Additional Measures and Consequences

In the invocation of a smart contract, the number of steps taken is an important measure of the complexity of the invocation, and the ultimate payments/effects are some of its important consequences. There are, however, additional measures and consequences, and all of them can be handled within our invention. Below we details just a few examples.

Smart contracts could be arbitrary programs, and the execution of a contract C can automatically trigger other executions of C itself, or other smart contracts. (Often, in fact, smart contracts are written in a Turing-complete language.) This fact can be an advantage, but also a drawback, and one may wish to contain the number of calls that an invocation I of contract C may cause to be made.

For example, the number of calls, #calls, can be specified within invoke, (as a separate component and/or as part of other components), and the fee, fee, of I can be adjusted so as to depend on #calls. Such dependency can be simply proportional, or may dramatically increase with #calls. A verifier of I can thus be asked to verify that #calls is correct, and that so is f ee, relative to all complexity measures, including #call.

Alternatively, or in addition, one may limit the number of calls. For instance, if the declared #calls is greater than a given bound, or if the number of calls C actually makes is greater than #calls, then, irrespective of the values of #steps and f ee, the invocation is considered invalid. All the mechanisms discussed above for individual and final verdicts apply straightforwardly to this new measure of complexity.

Also, one may distinguish between ordinary calls and ‘nested calls’. For instance, if an execution e of C, causes the execution e′ of contract C′, and the latter, in turn, causes the execution e″ of a contract C″, then e″ can be considered a nested call, of ‘level’ 2. Similarly one can have nested calls of level 3, 4, etc. Note that also nested calls and/or their levels can be declared in an invocation I, and the fee, the validity, and the handling of I can be straightforwardly extended so as to include this additional declared information.

One may consider, in addition to the direct net effects of an invocation I, also the effects of its calls. For instance, one may explicitly indicate in I the total amount of money that it causes to be transferred, directly or via its calls. Again, one can prohibit calls of a given level, or make them more expensive than regular calls.

### Incentives.

The verifiers of an invocation or set of invocations may be incentivized via proper rewards. In particular, a verifier of an invocation I may be eligible for a reward if his response about I agrees with the final verdict about I.

All or some (e.g., a sample of) such verifiers may be rewarded. The verifiers to be rewarded may be selected cryptographically (e.g., by cryptographic sortion, and/or via the help of a random beacon).⁴ Alternatively, such verifiers may be selected by a block constructor. The rewarded verifiers of an invocation I (or of a set of invocations S) and the final verdict of I (or of S) may be indicated in the same block. ⁴ Such a sample could also be selected by specialized party, that can itself be selected afresh very often. In particular, such a party can himself be selected by cryptographic sortition, digitally sign one or more verifiers to receive a reward, and its signature can appear in the block.

For instance, a block constructor u may insert in his block the final verdict V for I (or S), as well as information identifying one or more verifiers v to be rewarded. (Alternatively, information identifying the rewarded verifiers may be inserted in a subsequent block, and possibly also selected by another block constructor/proposer.) For example, u can also include in the blockchain the proof that a verifier v is indeed assigned to verfy I (or S), in addition to the final verdict V, so as to enable one to check whether v's response agrees with V. Alternatively, the constructor may omit to include V in his block. For instance, it suffices for him to include just v and v's digitally signed individual verdict, for a single verifier v of I or for multiple such verifiers whose responses are coherent. In fact, from such individual responses, one can deduce what the final verdict V is meant to be. For instance, if the block only contains the individual response about I of a single verifier v, then this information may be used to indicate that the final verdict about I coincides with the individual verdict of I (and, possibly, also indicates that v has been targeted for a reward). All rewarded verifier(s) can be paid automatically once identified in a block.

An honest block constructor may chose the verifier(s) of I to be rewarded at random, or in some other fashion. Even if a malicious constructor may choose them in a different way (e.g., by preferring malicious verifiers) the verifiers of I are still incentivized to report their true responses. Indeed, the majority of verifiers are expected to be honest, and so are, in expectation, block constructors.

Further, in order to reward the verifiers of one or more invocations I, or for their individual verdicts to be taken into consideration, one may need evidence that the verifiers indeed executed C correctly. Such evidence may includes some type of CS proof, a snark, or a stark. Such verifier-provided evidence could also be used and posted in a block as part of (or the entire evidence about) the final verdict about I.

In addition to positive rewards, the blockchain may also use punishments. For instance, a verifier v reporting a response about an invocation (or set of invocations) that is different from the final verdict about its correctness, may be fined. Such a fine may be automatically deducted from the money that v owns.

The blockchain may also envisage purposely registering in the blockchain at least one invocation I that is semantically invalid. This may help spotting (and possibly punish) verifiers assigned to verify the semantic validity I, who maliciously report that I is semantically valid (either directly or when reporting about the validity of a set of invocations including I).

For instance, users who cause the registration of invocations that are purposely semantically invalid may not do so because they are malicious, but because they have been selected to help spot malicious verifiers. Preferably, therefore, the selection of these helping users is secret (so that the verifiers of a purposely semantically invalid invocation have no idea that the invocation is so invalid) and random (so as to ensure that at least some honest helping users have been selected). For instance, the process used to select such helping users may be similar to that for selecting a verifier v for an invocation I or a set of invocations S: a helping user may be selected by digitally sign a given quantity Q deducible from the blockchain together with other data (e.g., the string “HELPING USER”), hash the signature and check whether it is smaller than a given target number. This process guarantees other users do not realize that a given user u has been selected to be a helping user, until u reveals a proof if his selection (in the above example his digital signature). This proof may be revealed after a final verdict about a purposely semantically invalid invocation I registered by u has entered the blockchain. Such a proof may be insterd in the blockchain very much as a valid transaction. This way, the fee or any fine that has been imposed to u, may be automatically reimbursed to u (possibly in addition to a reward), because anyone realizes that u acted in accordance to the protocol to help securing the honest functioning of the smart contracts in the blockchain.

### 3 Committed Declarative Smart Contracts

We now describe a special type of declarative smart contracts: committed declarative smart contracts (CDSC, for short). The invocations of such contracts temporarily hide at least some net effects of the corresponding executions. These invocations can be registered as before. Their syntactic validity can be checked as before. Verifiers can be assigned to sets of such invocations as before. And the final verdict can posted on the blockchain as before.

However, verifiers of these new invocations do not check their semantic validity as before. This is so because these new invocations temporarily hide at least some of the net effects of the executions they specify. These invocations in fact include a commitment to such net effects. (Such a commitment hides such net effects, but, at a later point in time, but leaves the door open to provably reveal, at some later point in time, what the originally committed net effects were.)

Thus, a verifier assigned to verify one such invocation I can reproduce the execution e specified by I, learning what all net effects of e are, but cannot determine whether the net effects committed to in I are those he computed himself. Accordingly, in his response, such a verifier reports his own personalized commitment to the net effects of e that he computed himself and were committed to in I, without knowing whether their values coincide. Such a personalized commitment cannot just be obtained by copying the corresponding commitment in I, and cannot be feasibly computed from the latter commitment either, or from any other personalized commitment. Indeed, the idea in a CDSC is to oblige a verifier of I to learn what the net effect hidden by I are, and then compute and include in his response his own commitment to such effects. In a sense, therefore, each verifier of I must act independently and really run the execution e called by I.

Only at a later point, the inventive system reveals information enabling one to verify the correctness of I, by enabling one to check whether the net effects committed in I coincide with the net effects committed (in a personalized fashion) in the responses of sufficiently many verifiers of I. Accordingly, a final verdict about an individual invocation or a set of invocations of CDSC can be posted on the blockchain, and incentives and/or punishments can be allocated to users as before, and in new ways as well.

Without any restriction intended, we describe additional details of CDSCs.

### 1. Committed Invocations.

A committed declarative invocation I of a smart contract C specifies an execution e of C (on given input/inputs and initial state) and other relevant data, very much like a declarative invocation, but hides a set s of net effect of e, by including instead a commitment to s.

A commitment to a given value x allows one to secretly pin-down x at a given point in time, but to prove at a later point in time what the pin-down value x was. For instance, to commit to a set of net effects s, I may include h=H(s), for a given (collision-resistant) hash function H. Indeed, s is hard to compute from h, if one has no idea about s. At the same time, eventually revealing s convinces anyone knowing h that the revealed s is indeed the original committed value. This is so because it is hard to compute any value z s such that H(z)=H(s). Alternatively, I may commit to a set of net effects, by separately including the hash of each of these effects. For instance, if s consists of new state of C generated by e, γ′, and the player-amount adjustments generated by e, a₁, a₂, . . . , then I may commit to s by including H(γ′), H(a₁), H(a₂), . . . . Alternatively yet, I may commit to a set of net effect s by including the root value of a Merkle tree whose nodes store the net effects in question. More generally, the inventive system may use other commitment methods to temporarily hide some net effects of I.

The relevant data of a (at least partially) committed declarative invocation of a smart contract may be as in an ordinary declarative invocation.

For simplicity, we may more simply refer to a committed declarative invocation I as a declarative invocation, or, more simply yet, as an invocation, if the context is clear enough. If we want emphasize that an invocation of a smart contract is not a committed declarative invocation, we may use the term ordinary invocation.

### Discussion and Additional Details

The discussion and additional details about ordinary invocations that are applicable to committed declarative invocations are automatically extended to the latter invocations.

Note that a committed invocation, digitally signed by a proper invoking user, continues to authenticate all the net effects of the relevant execution of C, although a set s of them may be authenticated in an indirect manner, that is, by authenticating a commitment to s.

As we shall see, the inventive system enables all users observing the blockchain to determine whether a committed invocation I of a contract C is correct, without burdening all users or too many users to compute the execution e specified by I.

Let us now see how such a committed invocation I is registered.

### 2. Registration of Committed Invocations.

A committed invocation I may enter the blockchain very much like an ordinary invocation. For example, the syntactic validity of I may be sufficient for I to enter the blockchain.

Checking such syntactic validity may include checking whether the fee of I is adequate for number of steps declared in I for the specified execution. Indeed, fee and declared number of steps may not be considered net effects of the execution e specified in I that must take place in the blockchain. Accordingly, the fee and the declared number of steps can openly appear in I.

Again, a block including a syntactically invalid committed invocation is considered invalid, and the syntactic validity of a committed invocation I may be required for forwarding I to other users during the propagation of I.

When a committed invocation I is registered in the blockchain, the system start the process of checking its correctness. Let us now proceed to illustrate this process.

### 3. Assignments of Committed Invocations.

A set S of one or more committed smart-contract invocations, registered in one or more blocks, is assigned to a set V, of verifiers, following any of the methods described for the assignment of a set of ordinary invocations.

### 4. Verification of Committed Invocations.

When the set S of committed invocations is registered in the blockchain, each verifier v in V_{S} executes the contract C of each invocation I in S on the proper input(s) and state, and then authenticates and propagates his responses. As already mentioned, such responses may include only a personalized commitment to some of the net effects of the execution e specified in I. Let us now discuss some possible example of such responses.

If I is blatantly invalid (e.g., if the number of steps of its invocation e exceeds that declared in I), then v indicates that this is the case in his response about S. For instance, by including in his response the pair (I, invalid).

In a second example, let e be the execution called by (specified in) I, let I declare the right number of steps for e, let ne consist of all net effects of e, presented in a predetermined order and fashion, and let I hide ne by including the commitment H(ne). Then, after reconstructing e (and thus ne), v may authenticate information identifying I and a, preferably personalized, commitment to ne. By a personalized commitment of v to ne, we mean a commitment hᵥ to ne such that (a) it is hard for v to compute hᵥ without knowing ne—even though v knows the commitment H(ne) included in I and might also know other commitments to ne—and (b) it is easy for anyone, given knowledge of ne and v, to compute v's personalized commitment to ne.

For instance, a personalized commitment of v to ne may consist of Hᵥ(ne), where Hᵥ is the hash function so defined: Hᵥ(x)=H(v, x). Thus, h=Hᵥ(ne)=H(v, ne) is indeed a commitment of v to ne. In fact, no one can find another value ne′ such that H(v, ne′)=h, and once once the value ne is revealed, anyone can verify that indeed h=H(v, ne). Moreover, this commitment of v is personalized, because v cannot easily compute it from the commitment H(ne) provided in I, nor from H(z, ne) if z≠v.

Note that hashing v together with ne is just one example of a personalized commitment of v to ne, and no limitation is intended. For instance, replacing v in H(v, ne) with any data preferably uniquely depending on v would work as well. Any form of personalized commitment to ne is in the scope of the invention.

(As for ordinary invocations, if the set V_{S} is selected via secret sortition, then v, in addition to his responses, also propagates a proof that he indeed belongs to V_{S}. Again, v may authenticate his response about each committed invocation I in S separately, or together very much as in the case ordinary invocations.⁵) ⁵ For instance, if the invocations in S are I₁, I₂, I₃, I₄, . . . , and the invocations I₁, I₃, . . . are valid (and respectively have the net effects ne₁, ne₃, . . . ) and the invocations I₂, I₄, . . . are blatantly invalid, then v may compute and propagate SIGᵥ((I₁, Hᵥ(ne₁)), (I₂, invalid), (I₃, Hᵥ(ne₃)), (I₄, invalid), . . . ). Again, more compactly, if I₁, I₂, I₃, I₄, . . . are the invocation of S in a given order, then v may authenticate and propagate the sequence (Hᵥ(ne₁)), 0, (ne₃), 0, . . . ), where 0 indicates that corresponding invocation is blatantly invalid. Verifier v may also authenticate his responses together, but so as to allow one to extract v's authenticated response about an individual invocation in S. For instance, v may construct a Merkle tree, each leaf of which stores v's response about a separate invocation in S, and then authenticate the value stored at the root of the Merkle tree.

Using a personalized commitment to the net effects ne of the execution e of a committed invocation I makes it hard for a verifier v in V_{S} to authenticate that I is valid—even if v were sure that invocation I was properly prepared!—without learning what the value ne is e.g., by truly running the execution e called by I. At the same time, upon learning ne, any one can verify whether the value ne whose commitment is included in I and the value whose commitment personalized by v is included in v's response about I are the same.

### Correctness of Committed Invocations.

An honest verifier in V_{S} only provides the right response, and thus a single response, about each committed invocation I in S. Such an invocation I is considered (to be proven) correct if the hidden net effects committed in I are the same as the net effected committed in the responses of at least a given number X of the verifiers in V. Invocation I may be considered incorrect if at least Y responses of verifiers in V_{S} indicate that I is invalid. Alternatively, I may be considered incorrect if, at a given point in the blockchain, it has not not yet been proven correct.

Notice, however, that without knowing ne it is hard to determine whether H(ne)=Hᵥ(ne). Thus, the system needs some way to determine which committed invocations are correct. Multiple such ways are described in what follows.

### 4.5 Revelation of Hidden Net Effects.

Let i be the proper party that has invoked I and let ne be the net effects, of the execution e specified by I, whose commitment appear in I. Let, without loss of generality intended, the way to commit to ne in I consist of a hash of ne. Assuming that i is honest, then, presumably, i (1) knows the value ne; (2) has properly computed and included in I the commitment H(ne); and (3) is desirous that the net effects ne actually take place in the blockchain.

Accordingly, when i sees that more than X verifiers v in V_{S} include a personalized commitment to ne—e.g., Hᵥ(ne)—in their responses, i propagates ne, preferably in an authenticated manner and with information identifying the invocation I.

Once ne is revealed, anyone observing the blockchain messages, realizes that the value ne is the same value committed to in I and in the personalized commitments of the responses of at least X of the verifiers in V_{S}. In other words, every observer sees that the committed invocation I is correct.

Notice that it is not necessary that it is the invoker i to reveal ne. For instance, it may be any entity (e.g., a special verifier assigned to a set S of committed invocations to which I belongs) who has executed e, computed ne, and realized that indeed ne is the same one committed to in I and in the personalized commitments of the responses of at least X of the verifiers in V_{S}.

It is now time to make official this realization in the blockchain.

5. Verdicts about Committed Invocations.

Let I be a committed invocation already registered in the blockchain, but not having a final verdict. Then, a constructor u of a new block B, who realizes that I is correct, he includes in B information indicating that I is correct, thus providing a final verdict about I.

The system may also provide for the simultaneous final verdict of all committed invocations about a set of committed invocations S already registered in the blockchain, for which no final verdict yet exists.

For instance, a user u constructing a new block B, who has learned which invocations in S are correct, may include in B a final verdict about such invocations in S. Such final verdict may also include information identifying the set S itself, and is preferably authenticated. If u authenticates B, then such verdict is automatically authenticated by u. Alternatively, u may separately authenticate the final verdict about invocations in S.

Alternatively, u may include in the block the authenticated responses of sufficiently many verifiers of V_{S}, so as to enable one to determine, from such included responses, invocations in S that are valid and invocations of S that are not. In doing so, it may use any of the methods discussed in the case of ordinary invocations.

### Discussion and Additional Details.

A block B may be considered valid not only if its ordinary transactions are valid, but also if its final verdicts about previously registered invocations (ordinary or committed) properly reflect the correctness of such invocations.

Other discussion and additional details described for ordinary invocations apply to committed invocations as well. This same holds for various variants and additions presented for ordinary invocations.

In particular, but without any limitation intended, the weighting for money techniques also applies to the verifiers of committed invocations. Accordingly we may treat a verifier with weight n as n separate verifiers.

Verifiers whose response about a committed invocation I are in agreement with established correctness of I and/or with the established revealed value of the net effects committed in I may be rewarded—e.g., by any of the incentive methods already described the verifiers of ordinary invocations or new ones.

Similarly, verifiers whose response about a committed invocation I are not in agreement with established correctness of I and/or with the established revealed value of the net effects committed in I may be fined or punished—e.g., by any of the incentive methods already described the verifiers of ordinary. In particular, they may become ineligible for being assigned to verify at least some other invocations.

The invoker of an incorrect committed invocation I may also receive special fines or be punished in some way.

### 4 Variants and Additions.

Let s be a set of net effects of the execution e specified by a committed invocation I of a smart contract C, and let h=H(s) be the commitment to s included in I. Then some party—e.g., a verifier assigned to I, such as a verifier assigned to a set of invocations that includes I—would have hard time computing s from H(s), if s is itself were sufficiently unpredictable. However, if s consisted of—say—just a few bits, then it would be possible for some party to try all possibilities for s until he finds a value that hashed yields h. To prevent this possibility, one could choose s to be very big—e.g., to consist of all net effects of e, so as to make harder for a party to guess all of them in their entirety. But even this could sometimes not be enough.

To guarantee that the committed net effects of e are hard to guess correctly, one may artificially include in these net effects a specially chosen quantity that is hard to predict. For instance, although the net effects of e one cares about were the new state γ′ and a few player-amount adjustment, a₁, . . . , aₖ, a proper invoker of I could artificially add to such net effects the content, x, of a special auxiliary variable of C at the end of the execution e, and let s=(γ′, a₁, . . . , aₖ, x). Indeed, even if the net effects of e may always be easy to predict, the computation of e may have, or may be engineered to have, quite unpredictable variable contents in order to generate its simple effects. Thus, if x were hard to predict, s=(γ′, a₁, . . . , aₖ, x) would be hard to predict from H(s), even if γ′, a₁, . . . , aₖ were very easy to predict. (Naturally, x would have a purely auxiliary role and should not be treated as a net effect that take places in the blockchain if the invocation I is correct.)

Alternatively, the value x may could depend on e and the execution of a possibly totally separate specified program P, on a totally separate specified input y contained in, or deducible from, I. Such a program P and input y may be chosen so as to make x hard to predict from P and y. For instance, the computation of P may include from time to time quantities obtained from the execution e. Alternatively, the computation of P(y) may be totally unrelated to e.

Again, I may contain a commitment to x, and a verifier v, assigned (directly or indirectly) to verify the execution e of I, may also be asked to compute x and to include a personalized commitment to x in his response. Only if the underlying values of these personalized commitments of sufficiently many verifiers assigned to I coincide with each other, and with the underlying value x committed to in I, can I be considered correct. Thus, a verifier assigned to I is encouraged to properly compute x if he wants his response about I to be properly counted.

Notice that in any of the above described and other possible variants that those skilled in the art may use, the total number of steps declared in I would have to include also the number of steps necessary to compute x, and thus may cause the payable fee of I to increase. But a proper invoker of I may be happy to pay a higher fee in order to be more confident that a verifier of I properly computes x.

Also, no matter in which manner such a value x is used, it may even be possible for I to include the real net effects of e—e.g., those that should indeed take place in the blockchain, if I is correct—in an open manner, and to have a personalized commitment to x to be I's only commitment. In this case, a verifier v, assigned to a set S containing I, is asked to produce a response (1) indicating whether the openly declared net effects of e are right and (2) including a personalized commitment to x. In this case the invocation I is considered correct if the value of x committed to in I coincides with value committed to in the responses of sufficiently many verifiers v assigned to S, and such responses indicate that the openly declared net effects of I are right.

Note that the mechanism described herein is applicable to other blockchain systems where it is desirable to randomly choose a subset of users for a particular purpose, such as verification, in a way that is generally verifiable. Thus, the system described herein may be adapted to other blockchain schemes, such as Ethereum or Litecoin or even blockchain schemes that do not relate directly to currency.

The system described herein may be adapted to be applied to and combined with mechanisms set forth in any or all of the following U.S. and PCT patent applications: 62/117,138 filed Feb. 17, 2015, 62/120,916 filed Feb. 26, 2015, 62/142,318 filed Apr. 2, 2015, 62/218,817 filed Sep. 15, 2015, 62/314,601 filed Mar. 29, 2016, PCT/US2016/018300 filed Feb. 17, 2016, 62/326,865 filed Apr. 25, 2016, 62/331,654 filed May 4, 2016, 62/333,340 filed May 9, 2016, 62/343,369 filed May 31, 2016, 62/344,667 filed Jun. 2, 2016, 62/346,775 filed Jun. 7, 2016, 62/351,011 filed Jun. 16, 2016, 62/353,482 filed Jun. 22, 2016, 62/354,195 filed Jun. 24, 2016, 62/363,970 filed Jul. 19, 2016, 62/369,447 filed Aug. 1, 2016, 62/378,753 filed Aug. 24, 2016, 62/383,299 filed Sep. 2, 2016, 62/394,091 filed Sep. 13, 2016, 62/400,361 filed Sep. 27, 2016, 62/403,403 filed Oct. 3, 2016, 62/410,721 filed Oct. 20, 2016, 62/416,959 filed Nov. 3, 2016, 62/422,883 filed Nov. 16, 2016, 62/455,444 filed Feb. 6, 2017, 62/458,746 filed Feb. 14, 2017, 62/459,652 filed Feb. 16, 2017, 62/471,562 filed Mar. 15, 2017, 62/507,074 filed May 16, 2017, 62/510,905 filed May 25, 2017, 62/522,927 filed Jun. 21, 2017, 62/536,061 filed Jul. 24, 2017, 62/541,568 filed Aug. 4, 2017, 62/548,201 filed Aug. 21, 2017, PCT/US2017/031037, filed on May 4, 2017, Ser. No. 15/551,678 filed Aug. 17, 2017, 62/564,670 filed on Sep. 28, 2017, 62/567,864 filed on Oct. 4, 2017, 62/570,256 filed on Oct. 10, 2017, 62/580,757 filed on Nov. 2, 2017, 62/607,558 filed on Dec. 19, 2017, 62/632,944 filed on Feb. 20, 2018 and 62/643,331 filed on Mar. 15, 2018, all of which are incorporated by reference herein.

Software implementations of the system described herein may include executable code that is stored in a computer readable medium and executed by one or more processors. The computer readable medium may be non-transitory and include a computer hard drive, ROM, RAM, flash memory, portable computer storage media such as a CD-ROM, a DVD-ROM, a flash drive, an SD card and/or other drive with, for example, a universal serial bus (USB) interface, and/or any other appropriate tangible or non-transitory computer readable medium or computer memory on which executable code may be stored and executed by a processor. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. In a transaction system where transactions are organized in blocks, a method of providing new blocks B^{r} and B^{r+1} relative to a sequence of prior blocks B⁰, B¹, . . . , B^{r-1}, the method comprising:
causing the block B^{r} to be constructed after confirming that the block B^{r} indicates initial states of transactions that are consistent with a state of the transactions in the block B^{r-1};
causing the block B^{r+1} to be constructed after confirming that the block B^{r+1} indicates initial states of transactions that are consistent with a state of the transactions in the block B^{r}; and
causing a plurality of entities to verify previously-unverified transactions of the block B^{r} after the block B^{r+1} is constructed.

2. A method, according to claim 1, wherein the transactions are smart contracts.

3. A method, according to claim 2, wherein a user constructs the block B^{r} in connection with posting a transaction to at least one of the smart contracts in the block B^{r}.

4. A method, according to claim 3, wherein the user also posts transaction results for the smart contracts in the block B^{r}.

5. A method, according to claim 4, wherein the user also posts a number of steps for execution of the smart contracts results for the smart contracts in the block B^{r}.

6. A method, according to claim 5, wherein the user also posts a fee that the plurality of entities receive for verifying transactions of the block B^{r}.

7. A method, according to claim 1, wherein the plurality of entities is a subset of all users of the block B^{r}.

8. A method, according to claim 7, wherein the plurality of entities is chosen randomly.

9. A method, according to claim 8, wherein choosing the plurality of entities randomly includes applying a cryptographic hash function to data that includes at least one of: time information, information about one or more of the blocks, data included in one or more of the blocks, or data deduced from one or more of the blocks.

10. A method of causing a block B in a blockchain to be added to the blockchain, comprising:
causing an entity to receive information corresponding to a previous block;
causing the entity to receive a declarative invocation of a smart contract execution on a given input, wherein the declarative invocation declares relevant results of the execution and other relevant data;
causing the entity to verify syntactic validity of the invocation; and
causing the entity to incorporate the declarative invocation in the block B in response to verifying the syntactic validity of the invocation.

11. A method, according to claim 10, wherein the relevant results specify at least one of: net effects of the smart contract execution, a resulting state of the smart contract after execution, and a number of steps for execution and wherein the other relevant data specifies at least one of: a caller of the declarative invocation, time information, block information, and a payable fee.

12. A method, according to claim 11, wherein the declarative invocation is syntactically valid if the fee is adequate for the number of steps for execution and a payer of the fee has sufficient assets to pay the fee, and wherein the fee is paid if the declarative invocation appears in the blockchain.

13. A method of causing a set of verifiers in a blockchain to be assigned to verify a set S of one or more declarative invocations of smart contract executions on given inputs, wherein the declarative invocations declare relevant results of the smart contract executions, the method comprising:
the verifiers receiving the set S;
the verifiers determining which of the declarative invocations in S are semantically valid; and
the verifiers providing authenticated responses of the one or more declarative invocations that are semantically valid.

14. A method, according to claim 13, wherein the set of verifiers are selected based on S, in a pseudo-random manner, via a given cryptographic function.

15. A method, according to claim 14, wherein at least one verifier determines that the at least one verifier has been selected via a computation that involves a secret key of the at least one verifier, and wherein the at least one verifier can prove to others that the at least one verifier has been selected.

16. A method, according to claim 13, wherein an invocation I in S is considered correct if responses of at least a given number of verifiers assigned to S indicate that I is semantically correct.

17. In a blockchain in which a set S of declarative smart-contract invocations has already been registered, a set of verifiers assigned to S, and the verifiers have provided authenticated responses about which of the invocations of S are semantically valid, a method of causing a verdict of the invocations of S to be incorporated in the blockchain, comprising:
having an entity receive the authenticated responses of the verifiers;
having the entity deduce correctness of the invocations of S; and
having the entity incorporate in the blockchain a final verdict about correctness of the invocations of S.

18. A method, according to claim 17, wherein the final verdict of an invocation I in of S indicates that I is correct if the responses of at least a given number of the verifiers assigned to S indicate that I is semantically valid.

19. A method, according to claim 17, wherein if the final verdict of an invocation I of S indicates that I is correct, causing other users to update the state of the smart contract and to consider the declared net effects of the execution of the smart contract to have taken place.

20. A method of causing a block B in a blockchain to be added to the blockchain, comprising:
causing an entity to receive information corresponding to a previous block;
causing receipt of a committed declarative invocation of a smart contract execution on a given input, wherein the committed declarative invocation declares at least some relevant results of the execution, a commitment to other relevant results of the execution, and other relevant data;
causing verification of the syntactic validity of the committed declarative invocation; and
causing incorporation of the committed declarative invocation in the block B in response to verifying the syntactic validity of the committed declarative invocation.

21. A method, according to claim 20, wherein the relevant results specify at least one of: a net effects of execution, a resulting state of the contract after execution, and a number of steps and wherein the other relevant data specifies at least one of: a caller of the invocation, time information, block information, and a payable fee.

22. A method, according to claim 21, wherein the declarative invocation is syntactically valid if the fee is adequate for the number of steps and the payer of the fee has sufficient assets in the system to pay the fee, and wherein the fee is paid if the invocation appears in the blockchain.

23. A method of causing a set of verifiers in a blockchain to be assigned to verify a set S of declarative invocations, including at least one committed declarative invocation I specifying an execution e of a smart contract on given inputs, wherein I includes a commitment to at least some relevant results rr of e, comprising:
the verifiers receiving the set S;
the verifiers reconstructing execution e so as to compute the relevant results rr;
the verifiers providing authenticated responses including personalized commitments to rr of the verifiers.

24. A method, according to claim 23, wherein the assigned verifiers are selected based on S, in a pseudo-random manner, via a given cryptographic function.

25. A method, according to claim 34, wherein at least one verifier can determine that the least one verifier has been selected via a computation that involves a secret key of the least one verifier, and wherein the least one verifier can prove to others that the least one verifier has been selected.

26. A method, according to claim 23, wherein the committed declarative invocation I in S is considered correct only if responses of at least a given number of verifiers assigned to S include a personalized commitment to the relevant results rr committed to in I.

27. In a blockchain in which a set S of declarative smart-contract invocations has already been registered, a set of verifiers assigned to S, wherein the set S includes at least one committed declarative invocation I specifying an execution e of a smart contract on a given input, and wherein I includes a commitment to at least some relevant results rr of e, and the verifiers have provided authenticated responses about the invocations of S, a method of causing a verdict of the invocations of S to be incorporated in the blockchain, comprising:
having an entity receive the authenticated responses of the verifiers;
having the entity deduce correctness of the invocations of S; and
having the entity incorporate in the blockchain a final verdict about the correctness of the invocations of S.

28. A method, according to claim 27, wherein the responses of at least a given number of the verifiers assigned to S include a personalized commitment to the same relevant results rr committed to in I, and wherein the final verdict of the committed declarative invocation I in S indicates that I is correct.

29. A method, according to claim 28, wherein the final verdict of the correctness of I causes other users to update the state of the smart contract and to consider the net effects of the execution e of the smart contract to have taken place.

30. Computer software, provided in a non-transitory computer-readable medium, comprising:
executable code that implements the method of one of the preceding claims 1-29.
